(19) United States
(12) Patent Application Publication
(10) Pub. No.: US 2016/0219863 A1
(43) Pub. Date: Aug. 4, 2016

(54) APPLICATION DEVICES, EQUIPMENTS AND METHODS TO ISOLATE DELIVERY OF EXOGENOUS CHEMICAL SUBSTANCES ONTO PLANT FOLIAGE AREAS IN ORDER TO MINIMIZE THE RELEASE TO THE ENVIRONMENT

(71) Applicants: Sepehr Asgari, Zionsville, IN (US); Said Asgari, Zionsville, IN (US)

(72) Inventors: Sepehr Asgari, Zionsville, IN (US); Said Asgari, Zionsville, IN (US)

(21) Appl. No.: 14/612,667

(22) Filed: Feb. 3, 2015

(51) Int. Cl. A01M 21/04

(52) U.S. Cl. CPC A01M 21/043

(57) ABSTRACT

An apparatus for applying a herbicide to a plant includes two half-shells biased together to define a chamber therebetween in a closed position. The half-shells are manually separable into an open position. An absorbent material is impregnated with the herbicide and disposed in the chamber. The absorbent material is exposed in the open position.

### BACKGROUND

For many purposes, natural and synthetic chemical substances such as but not limited to biological agents, fertilizers, gametocides, herbicides, organics, pesticides, fungicides, bactericides, viricides, insecticides, miticides, nematicides, molluscicides, defoliants, desiccants, plant growth regulators, nutrients, salts, vinegar, and or any mixtures of these, or any substance similar to these have been delivered, sprayed, or applied to the foliage (e.g., a cluster of leaves, flowers, branches, and other non-woody above-ground parts) of plants. Unfortunately, when these chemical substances are applied, only a small amount of ingredients actually are effectively applied to the plant and the rest is wasted by being released into the environment. Moreover, these releases to the environment can be damaging. These releases may be harmful to other plants within a radius of the affected area where the substance was applied and to the environment. For example, herbicides are intended to be lethal only to weeds. However, if they are released into the environment, they are also lethal to the surrounding fruits, vegetables, flowers, gardens, lawns, landscapes, crops, agricultural areas, etc., and/or cause death, injury, and/or disease in humans, animals, and any other living thing.

Exogenous chemical substances that are applied (being sprayed, squirted, etc.) on plants are meant to be only for the plant that it is being applied to. However, more often than not, the substances from the exogenous chemical substances are introduced onto other plants, soil, water, etc. that the substances were not intended for. A great amount of the chemical substances are being wasted in addition to the negative effects they can have to the environment. Thus, the current methods for applying these substances are not an efficient operation. Other problems include but are not limited to the following: unintended transportation of the applied chemical substance away from the intended site by droplet, evaporation, rain, artificial rain wash, dew, mist, etc. This reduces the substances' effective application and therefore its dose required for biological effectiveness to the desired plant. Thus, its effectiveness may not be reliable. These applications are ineffective and/or inefficient because only a portion of the applied substance actually is being reached to the desired site where it may obtain its desired biological activity and effects on the plant.

In addition, the substances are also being unintentionally applied onto soil and through that action, seep into the soil, rivers, and streams or become absorbed by the roots of other unintended plants. Uncontrolled application of exogenous chemical substances may contaminate soil and water, kill bugs, and/or become airborne and be inhaled by animals and humans, which causes health problems. The current methods are not entirely effective because over time many factors such as weather (e.g., rain, wind, evaporation, etc.) can create releases that reduce the effectiveness of these substances. Dew or any other kind of condensation that forms on the targeted plants can mix with the substances, making it diluted, which is less potent, or wash the substances off of the plants. In some cases, extra amounts of these chemical may be used in order to provide adequate results. However, this is inefficient, time consuming, does not always work, and does not provide reliable results.

The term “exogenous chemical substance” as used herein means a chemical substance, whether naturally or synthetically obtained, which is applied to a plant to result in expressing a desired biological activity. Examples of exogenous chemical substances include, but are not limited to, chemical pesticides (such as herbicides, algicides, fungicides, viricides, insecticides, miticiedes, nematicides and molluscicides), plant growth regulators, fertilizers and nutrients, gametocytes, defoliants, dessicants, mixture thereof and the like.

### SUMMARY

The present invention relates to devices, systems, and methods for applying, placing on, delivering, spraying, or squirting natural and synthetic chemicals substance only on targeted plants. By using the following devices, exogenous chemical substance to isolate the exogenous chemical substance delivery to the foliage of the desired plant will not be wasted and will stay on the intended plant area, therefore making it more effective. It also eliminates the release-spreading problems of wind, fog, dew, rain, etc. Furthermore, by using the following devices to apply substances only to the intended plant and not to surrounding plants or the environment, the waste of exogenous chemical substances usage rate is reduced. This will make the entire process less polluting to the environment, reduce the usage rate, and thus be cheaper. This invention improves the method for delivering and the effectiveness and reliability of exogenous chemical substance applications.

The present inventor has observed that delivering exogenous chemical substance only to the foliage by isolating the site of application and/or containing plants during and after application, using the following devices and methods, improves methods for delivering of exogenous chemicals substances to the plants and protects the surrounding plants and reduces/prevents the release into the environment. Thus, the invention provides effective and reliable results since the substances remain on the plants, crops, gardens and lawns. Once the delivery is complete, the devices may be removed and disposed of to prevent the residue from entering the environment.

Using these inventive methods and devices reduces the amount of exogenous chemical substances by applying and delivering the chemical only to the targeted or desired plants, thus resulting in less chemical use and expense. It is also more effective since the exogenous chemical substances are in direct contact with the foliage site and the entire dose is being retained on the site to perform its biological action. Thus, the invention is more effective, uses less chemicals, is cheaper and more reliable, and produces more consistently effective results. It also produces a more rapid and reliable biological effect of the plants.

The invention comprises, in one form thereof, an apparatus for applying a herbicide to a plant, including two half-shells biased together to define a chamber therebetween in a closed position. The half-shells are manually separable into an open position. An absorbent material is impregnated with the herbicide and disposed in the chamber. The absorbent material is exposed in the open position.

The invention comprises, in another form thereof, a method for applying a chemical to a plant, including biasing two half-shells together to define a chamber therebetween. An absorbent material is impregnated with the chemical. The absorbent material is placed in the chamber. The two half-shells are pulled apart and a portion of the plant is inserted between the two half-shells. The two half-shells are allowed to be biased together such that the portion of the plant is in the chamber and is in contact with the absorbent material in the chamber.

The invention comprises, in yet another form thereof, a method for applying a chemical to a plant, including biasing an absorbent material impregnated with the chemical against the plant. The absorbent material is sealed against the plant in a substantially water-tight manner.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of one embodiment of an exogenous chemical substance delivery clip of the invention.

FIG. 2a is a rear view of an embodiment of an exogenous chemical substance delivery bandage of the invention.

FIG. 2b is a front view of the exogenous chemical substance delivery bandage of FIG. 2a.

FIG. 2c is a front view of the exogenous chemical substance delivery bandage of FIG. 2a with the backing sheet partially removed.

FIG. 2d is a side view of the exogenous chemical substance delivery bandage of FIG. 2a.

FIG. 3a is a plan view of the bandage of FIGS. 2a-d applied to a leaf.

FIG. 3b is a plan view of another embodiment of an inventive bandage applied to a leaf.

FIG. 4 is a front view of an embodiment of an exogenous chemical substance delivery containment dome of the invention applied to a plant.

FIG. 5 is a front view of an embodiment of an exogenous chemical substance delivery containment tube arrangement of the invention applied to a plant.

FIG. 6a is a front view of another embodiment of an exogenous chemical substance delivery containment tube of the invention.

FIG. 6b is a front view of yet another embodiment of an exogenous chemical substance delivery containment tube of the invention.

FIG. 6c is a front view of still another embodiment of an exogenous chemical substance delivery containment tube of the invention.

FIG. 6d is a front view of another embodiment of an exogenous chemical substance delivery containment tube of the invention.

FIG. 6e is a front view of yet another embodiment of an exogenous chemical substance delivery containment tube of the invention.

FIG. 6f is a front view of still another embodiment of an exogenous chemical substance delivery containment tube of the invention.

FIG. 6g is a front view of another embodiment of an exogenous chemical substance delivery containment tube lid of the invention.

FIG. 6h is a front view of yet another embodiment of an exogenous chemical substance delivery containment tube lid of the invention.

FIG. 7 is a front view of another embodiment of an exogenous chemical substance delivery containment dome of the invention applied to a row of plants.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

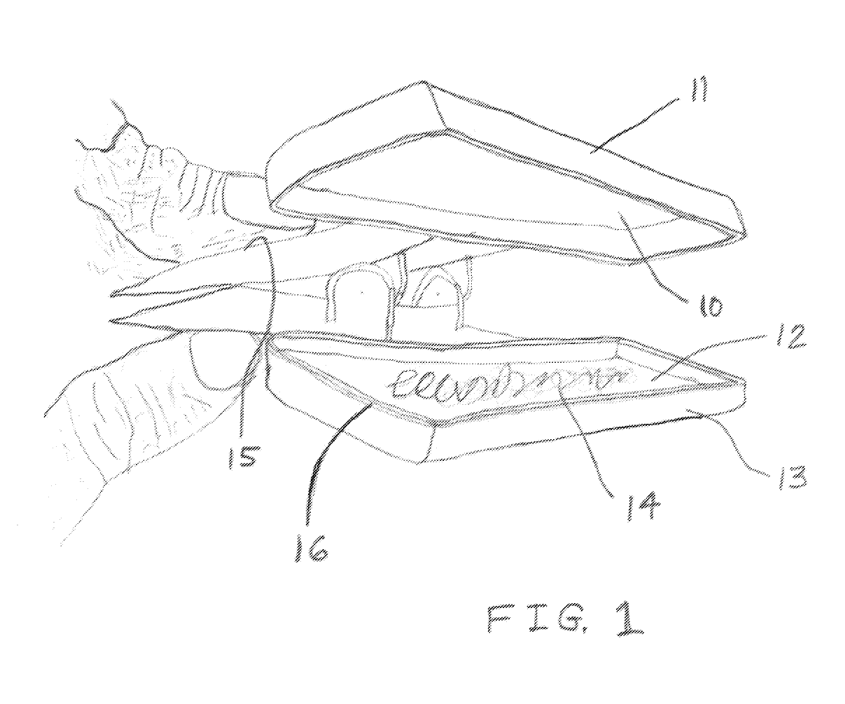

In FIG. 1 there is shown one embodiment of an exogenous chemical substance delivery clip of the invention in the form of a peg or clip with two half-shells 11, 13 having one or more storage spaces 10, 12 located at one or both sides of the contact (hold) areas. The purpose of the storage space is to receive and allow the placing of a piece of sponge, cotton, cloth, or any other absorbent material 14 capable of containing the desired exogenous chemical substances. Then, chemical substances such as herbicides are added to this absorbent material 14. Absorbent material 14 may be adhered to or otherwise attached to one of half-shells 11, 13. A seal 16 of thin rubber or other similar material may be added to the edges of the storage areas in order to keep better contact and prevent the release of the chemical substances from the storage area. A plastic, acrylic sheet or any other similar sheet may be placed on the absorbent material 14 and the clip closing area (cover sheet) to prevent evaporation or release of the chemical substances from the absorbent area.

In use, the clip, which is bias into a closed position by a spring 15 (only schematically depicted in FIG. 1), is opened manually, and the cover sheet is removed from the storage area. The plant's foliage is placed in-between the half shells 11, 13. The clip is then allowed to close to seal the foliage within a chamber defined by the closed half shells 11, 13. The closing pressure exerted by the spring should not be so great as to cut the leaf and should not be so small as to allow the clip and the chemical substances to slip and fall off from the plant's foliage. By closing the clip, the mechanism is sealed, and isolates the chemicals and the foliage together in a closed compartment. Thus, the chemical substances inside are prevented from getting released into the environment by rain, wind, spill, and/or other factors. The mechanism allows the chemical substances to come in contact with the plant's foliage surfaces and affect the plant without any of the previously mentioned consequences. One or more of these clips may be applied to the plant in order to have an effective amount of chemical substances in contact with the plant. The shape of this Exogenous Chemical Substance Delivery Clip may vary and the shape of the storage area and its dimensions may be in any regular or non-regular geometrical shape with a contact area of more than 0.0001 square inches and less than 10000 square inches. The volume of the storage area may be more than 0.0001 cubic inches but less than 10000 cubic inches.

In the case of herbicides, once the weed is dead, it and its roots may be removed from the soil. The weed with the device may be disposed of properly to prevent the herbicide from being released to the environment.

The materials used in Exogenous Chemical Substance Delivery Clip may include, but are not limited to the following:

Any such materials as plastic, metals, nylon, rubber, wood, etc. or combination of the materials can be used for the Exogenous Chemical Delivery Clip. Absorbent materials such as, but not limited to sponge, cotton, fabrics, polyesters, paper, recycled materials etc. may be used to absorb the chemical substances and keep it in the storage area of the Exogenous Chemical Substance Delivery Clip. Rubber, plastic etc. may be used as a better sealant to the edge of the storage area of the Exogenous Chemical Substance Delivery Clip. A plastic or any plastic-like sheet or any other material may be placed or stuck on the storage areas to cover and seal it and prevent the chemical substances from being released into the environment.

The shape and the area of the bandage may vary to a regular or irregular geometric shapes and the area may vary from 0.01 square inches to 10000 square inches. The shape of the pad also may vary in any geometric shape from 0.001 square inches to 10000 square inches so long as it is smaller than the bandages area and is located within the bandages edges, which allows it to be surrounded by the bandage's sticky area on the leaf. This will allow the bandage to seal all around the pad and will not allow the release of the chemical substance on the pad to the environment.

Although a specific embodiment of a clip is shown in FIG. 1, it is within the scope of the invention for the clip to be in the form of a binder clip, typically used for binding sheets of paper together, or a spring biased clip, such as is typically used to clip a bag of foodstuffs (e.g., chips) in an substantially air-tight state, or such as is typically found at the top of a clipboard.

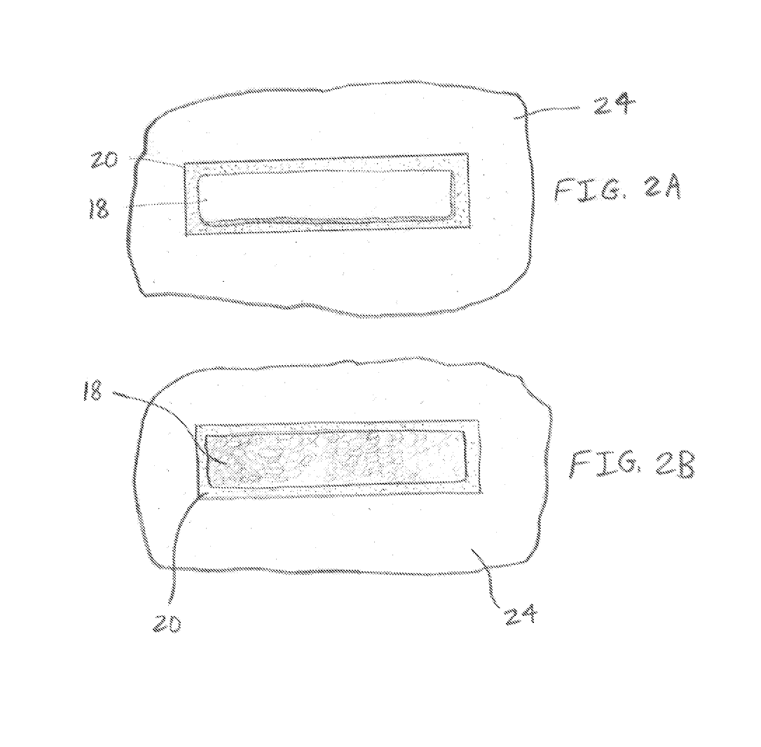

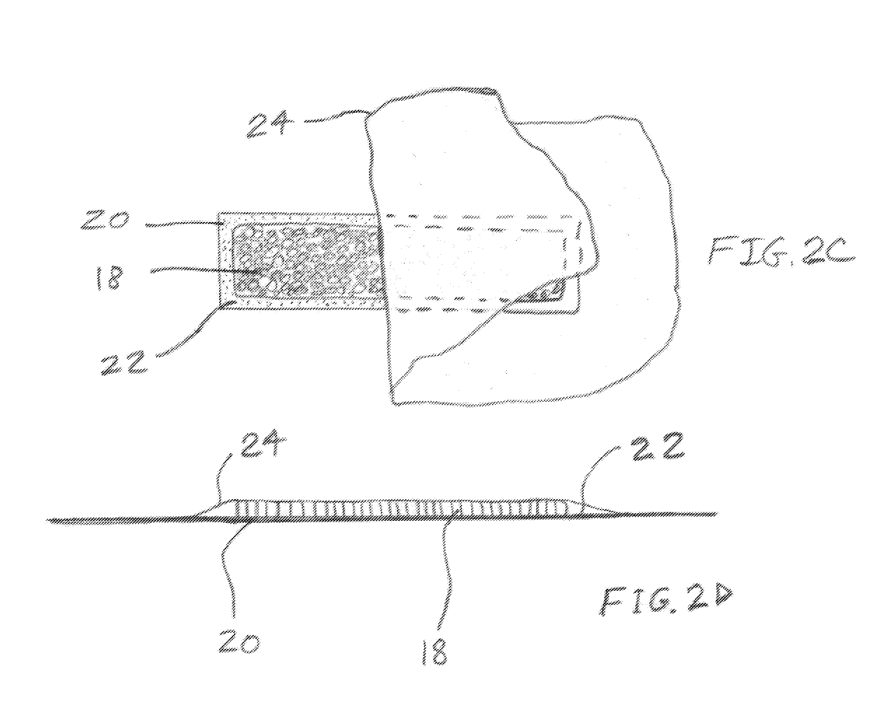

In FIGS. 2A-D and 3a there is shown one embodiment of an adhesive exogenous chemical substance delivery bandage that is similar to an adhesive medical bandage with an absorbent pad 18 saturated with weed killer or some other exogenous chemical substance. Pad 18 is adhered to a plastic strip bandage 20 having an adhesive surface 22. Pad 18 and adhesive surface 22 are covered with a plastic peel-off cover sheet 24 to seal the chemical substance to the pad 18. To apply the Exogenous Chemical Substance Delivery Bandage, plastic sheet 24 is peeled off of the bandage 20 and the pad 18 is applied to the plant's leaf. The plastic, fabric, latex, etc. of bandage 20 sticks (such as by glue, but not limited to glue) to the surrounding area of the leaf to hold it in place, sealing the pad 18 to the leaf, and preventing the chemicals from being released to the environment.

The materials used for the bandage 20 may include, but are not limited to, plastic, woven fabric, and latex. Pad 18 may be made of any absorbent material such as fabric, sponge, recycled materials, etc.

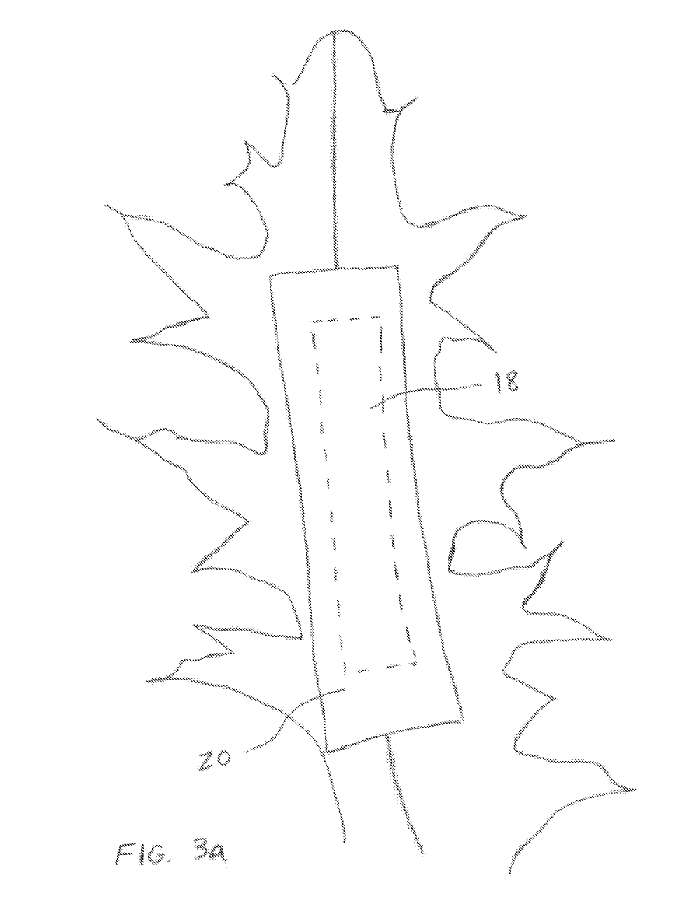

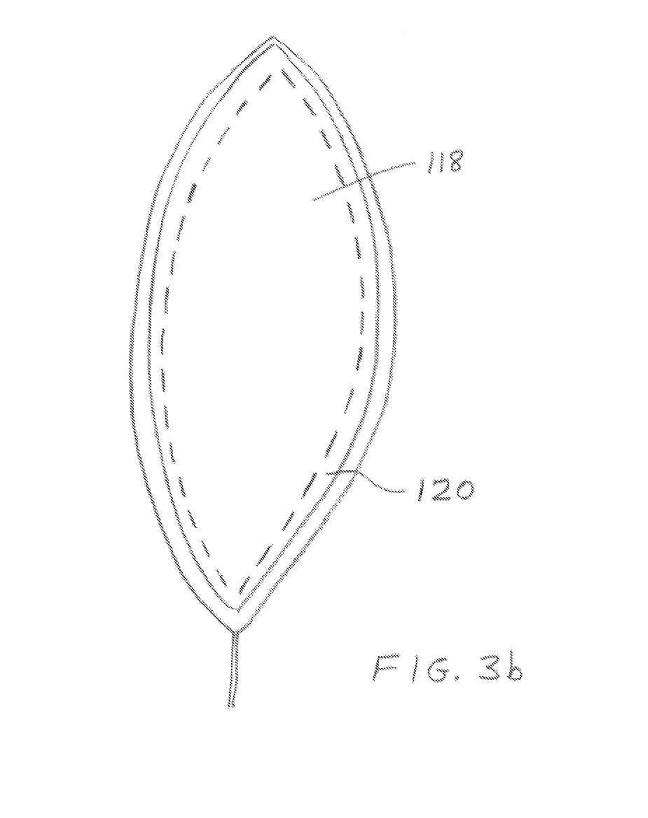

Pad 18 and bandage 20 are both shown as being rectangular. However, in another embodiment (FIG. 3b), pad 118 and bandage 120 are substantially oval shaped and sized to match the shape and size of a leaf or other foliage of the plant. This may maximize or optimize the surface area of contact between the pad and the foliage, and thereby deliver the chemical to the plant in an efficient and effective manner. It is to be understood that the pad and/or the bandage may be sized and shaped to match a leaf of any size and shape.

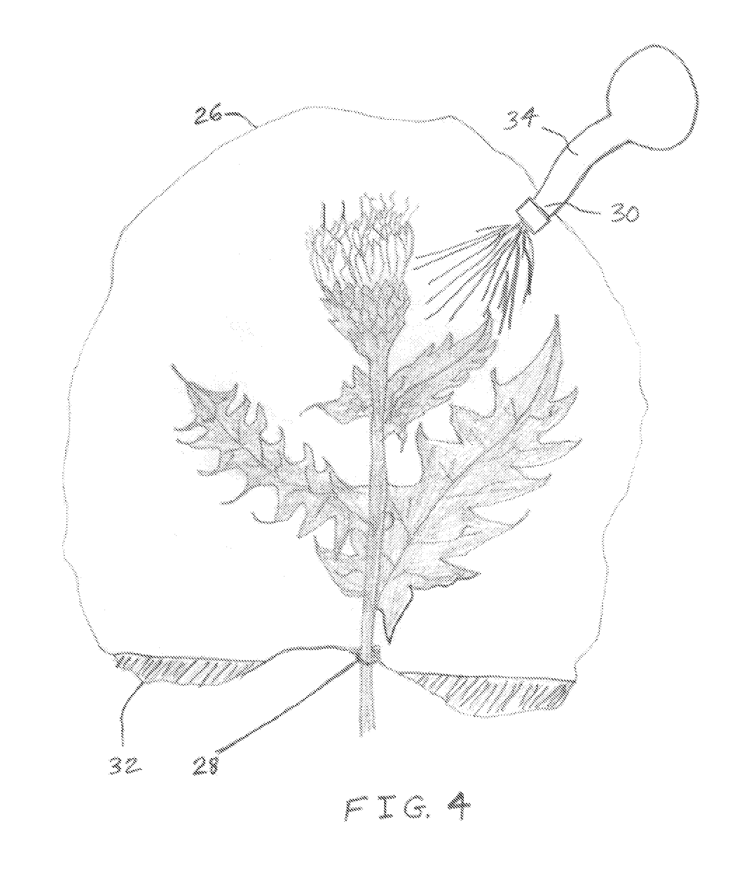

In FIG. 4 there is shown one embodiment of an exogenous chemical substance delivery dome including a seal air-tight and water-tight flexible dome 26 tied to a stem of the plant by a strip of elastic or string 28. Dome 26 has a sealable opening 30 through which an exogenous chemical substance may be sprayed or poured into dome 26 as shown. The bottom of the dome provides a reservoir 32 for collecting and containing excess chemicals that fall off the plant.

Dome 26 may have a bouffant (puffed out) cap shape and may be roomy inside with elastic tight enough to close its opening tight to the application area. The string to tie the bouffant opening to the weed may be tape, glued, stick, elastic, etc. Thus, any liquid droplets are prevented from escaping from inside of the Exogenous Chemical Substance Delivery Containment Dome to the environment. The Exogenous Chemical Substance Delivery Containment Dome may be colorless or any color, solid, or of various designs. Dome 26 may measure anywhere from one inch to eight thousand (8000) inches tall and/or wide. An excess bouffant area around the elastic area provides the reservoir to prevent the liquid from dripping on the surrounding plants. If exogenous chemical substance settles in the reservoir, sun and heat may evaporate the exogenous chemical substance in the bouffant, and the evaporated substances may come in contact with the plant, further promoting its biological effect on the plant. In addition, the evaporating substance is still contained within the Exogenous Chemical Substance Delivery Containment Dome, so none of it is released into the environment. Thus, dome 26 maximizes the effect of the substance being applied and reduces the amount being wasted significantly.

An example method of substance application includes, but is not limited to, placing an Exogenous Chemical Substance Delivery Containment Dome puffed out over the targeted plant foliage or the entire plant. The elastic is allowed to tighten to the plant. The spray/squirt nozzle of the substance is inserted into the opening 30, and the plant is sprayed. One or more openings 30 on the Exogenous Chemical Substance Delivery Containment Dome (preferably one opening on the side) allow the spray nozzle 34 into the dome for spraying, but opening(s) 30 close once spraying is finished and the spray nozzle comes out of the opening.

Another variation of this containment device is such a mechanism that can be used on more than one plant, by having the elastic tie to itself rather than a specific plant. This variation is for a row of plants being covered by a single Exogenous Chemical Substance Delivery Containment Dome 36 (FIG. 7). Some exogenous chemical may be released to the soil by the plants 38 using this method.

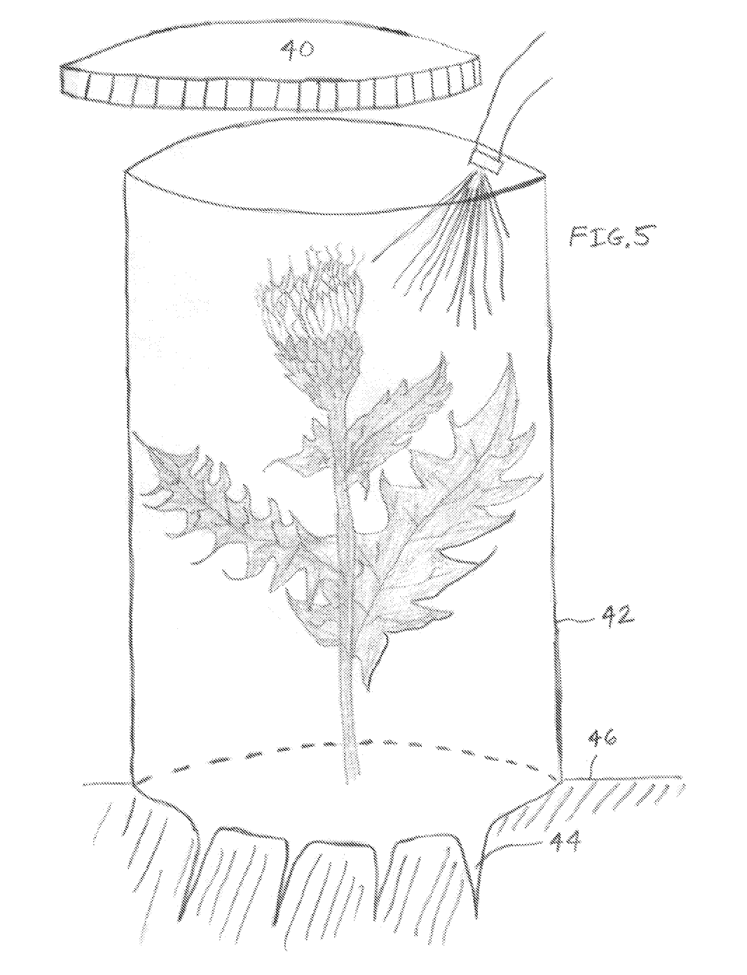

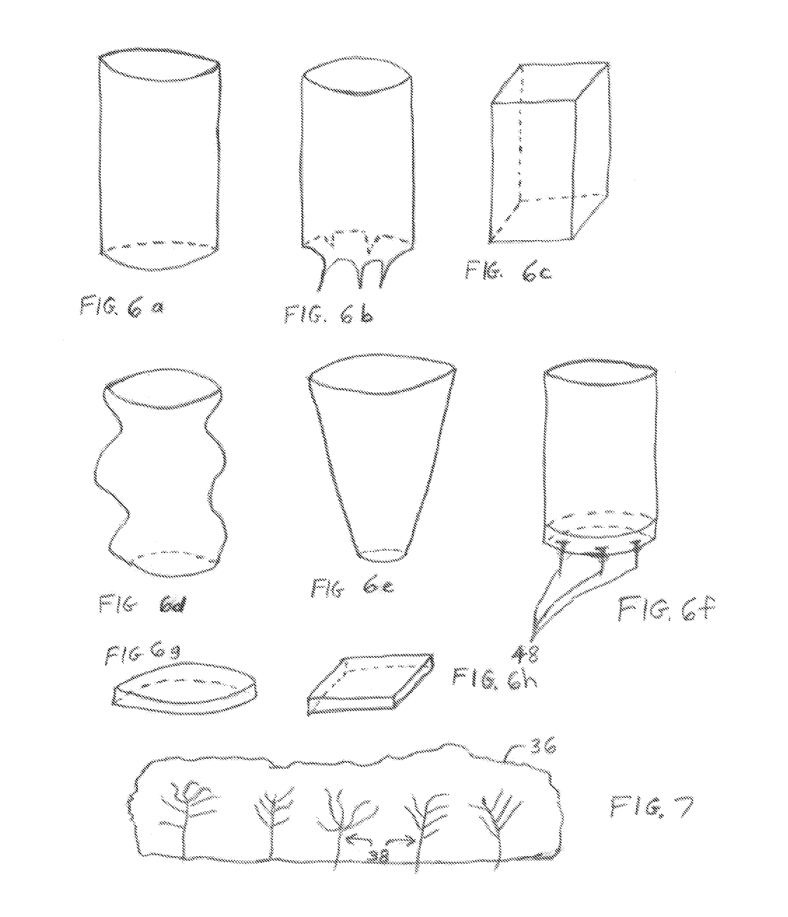

In FIG. 5 there is shown one embodiment of an exogenous chemical substance delivery containment hollow tube arrangement including a lid 40 capping a hollow tube 42 having spikes 44 on a bottom end for attaching tube 42 to the ground 46. Tube 42 can be of any regular or irregular shape, as shown in FIGS. 6a-f. The lid may also be of various shapes, as shown in FIGS. 6g-h. The Exogenous Chemical Substance Delivery Containment Hollow Tube may have a sharp needle-shaped edge, or nails 48 (FIG. 6h), at the bottom end in order to go into the ground and anchor it while installing it on and around the plant.

During use, the Exogenous Chemical Substance Delivery Containment Hollow Tube may be placed around the targeted plant (the plant goes inside the tube). Exogenous Chemical substance may be sprayed/squirted from a nozzle from a top or side opening into the containment area. The opening may then be closed (e.g., with a lid), or the opening may close itself. The Exogenous Chemical Substance Delivery Containment Hollow Tube, once in place, enables an exogenous chemical substance to be applied to the plant from the top opening or from a side opening. Then a lid, cap, shell casting, tape, adhesive, elastic, or string, etc. may be applied to close and isolate and contain the exogenous chemical substance to the plant and prevent it from being released to the environment. Some chemical substance may be released to the soil underneath the plant in this method.

The materials used in the tube arrangement may include, but are not limited to, any materials such as plastic, acrylic, cotton, fabric, polyester, paper, leather, etc. or combination of the materials such as nylon and fabric as long as the material is not reactive with the liquid sprayed. However, plastic (acrylic) is preferred. It may also be a net (having small holes) to allow vaporization (if vaporization is required by the labeling of the exogenous chemical substance manufacturer) or solid (without any holes) to keep the exogenous chemical substance inside the containment by the plant. The elastic may be tight enough to close its openings tight to the plant, or a string may be used to tie the Exogenous Chemical Substance Delivery Containment Hollow Tube opening to the plant or adhered, glued, taped, or slicked or etc.

The Exogenous Chemical Substance Delivery Containment Hollow Tube material used may include, but not limited to,: glass, ceramic, polybutylene, plastic, cotton, fabric, polyester, paper, leather, metals, acrylic, PVC, fiberglass, High Density Polyethylene (HDPE), natural and/or synthetic rubbers, etc., or combination of such materials or recycled materials. It may be clear or colored or designs such as, but not limited to, flowers, and drawings. It also may be flexible or rigid.

In the case of pesticide as the chemical substance, once the weed is dead, the weed and the Exogenous Chemical Substance Delivery Containment Hollow Tube isolating delivery devices may be removed and disposed of properly, thus eliminating the release of the exogenous chemical to the environment. For the Exogenous Chemical Substance Delivery Containment Hollow Tube, the contaminated soil at the bottom of the tube may also be removed and disposed of properly. Some exogenous chemical may be released to the soil or evaporated using some of these methods.

What is claimed is:

1. A method for applying a chemical to a plant, comprising:
biasing two half-shells together to define a chamber therebetween;
impregnating an absorbent material with the chemical;
placing the absorbent material in the chamber;
pulling the two half-shells apart and inserting a portion of the plant between the two half-shells; and
allowing the two half-shells to be biased together such that the portion of the plant is in the chamber and is in contact with the absorbent material in the chamber.

2. The method of claim 1, wherein the portion of the plant and the absorbent material are sealed in the chamber in a water-tight manner.

3. The method of claim 1, further comprising peeling a cover sheet off of the absorbent material before the allowing step.

4. The method of claim 1, wherein the two half-shells are biased together by a spring.

5. The method of claim 1, further comprising providing a flexible seal along an outer edge of at least one of the two half-shells.

6. The method of claim 1, further comprising:
determining that the plant is dead;
removing roots of the plant from soil; and
disposing of the plant with the half-shells still attached to the portion of the plant.

7. An apparatus for applying a herbicide to a plant, comprising:
two half-shells biased together to define a chamber therebetween in a closed position, the half-shells being configured to be manually separated into an open position; and
an absorbent material impregnated with the herbicide and disposed in the chamber, the absorbent material being exposed in the open position.

8. The apparatus of claim 7, wherein at least one of the two half-shells includes an edge biased against the other half-shell in the closed position, the apparatus further comprising a sealant disposed along the edge and configured to seal a portion of a plant and the absorbent material in the chamber in a substantially water-tight manner.

9. The apparatus of claim 8, wherein a part of the plant extends past the sealant and out of the chamber.

10. The apparatus of claim 8, wherein the sealant comprises a solid, flexible seal attached to the edge of at least one of the two half-shells.

11. The apparatus of claim 7, further comprising a cover sheet covering the absorbent material and configured to be manually peeled away from the absorbent material.

12. The apparatus of claim 7, further comprising a spring biasing the two half-shells into the closed position.

13. The apparatus of claim 7, further comprising a clip biasing the two half-shells into the closed position.

14. The apparatus of claim 7, wherein each of the two half-shells includes a respective recess, the two recesses defining the chamber.

15. A method for applying a chemical to a plant, comprising:
biasing an absorbent material impregnated with the chemical against the plant; and
sealing the absorbent material against the plant in a substantially water-tight manner.

16. The method of claim 15, wherein the biasing comprises biasing the absorbent material against the plant between two half-shells defining a chamber therebetween, the absorbent material and a portion of the plant being disposed in the chamber.

17. The method of claim 16, wherein the two half-shells are biased together by a clip.

18. The method of claim 16, further comprising providing a flexible seal along an outer edge of at least one of the two half-shells.

19. The method of claim 16, further comprising:
determining that the plant is dead;
removing roots of the plant from soil; and
disposing of the plant with the half-shells still attached to the portion of the plant.

20. The method of claim 15, further comprising peeling a cover sheet off of the absorbent material before the biasing.
